(19) United States
(12) Patent Application Publication
(10) Pub. No.: US 2023/0416948 A1
(43) Pub. Date: Dec. 28, 2023

(54) COMPOSITE FIBER CAPABLE OF CHANGING COLORS BY VARIOUS EXTERNAL STIMULI AND MANUFACTURING METHOD THEREOF

(71) Applicants: Hyundai Motor Company, Seoul (KR); Kia Corporation, Seoul (KR); INDUSTRIAL COOPERATION FOUNDATION JEONBUK NATIONAL UNIVERSITY, Jeonju-si (KR)

(72) Inventors: Hong Chan JEON, Seoul (KR); Sung June PARK, Jeonju-si (KR); Min Jae CHOE, Imsil-gun (KR); Dong Ho SIN, Jeonju-si (KR)

(21) Appl. No.: 17/994,871

(22) Filed: Nov. 28, 2022

(30) Foreign Application Priority Data
Jun. 23, 2022 (KR) 1020220076551

(51) Int. Cl. D01F 8/16; G01K 11/14; D01F 1/04; D01D 11/06; D01F 1/08

(52) U.S. Cl. CPC D01F 8/16; G01K 11/14; D06M 2101/30; D01D 11/06; D01F 1/08; D01F 1/04

(57) ABSTRACT

The present disclosure relates to a composite fiber capable of discoloration, and more particularly, to a composite fiber capable of discoloration by various external stimuli such as heat, electrical signals, mechanical external stimuli, etc. by filling a hollow of an elastic hollow fiber containing a thermochromic pigment and an elastic polymer with a liquid metal, and a manufacturing method thereof. The composite fiber capable of discoloration according to the present disclosure includes: a hollow fiber containing a thermochromic pigment and an elastic polymer, a liquid metal filled in the hollow of the elastic hollow fiber, a metal wire having one end inserted into the liquid metal and the other end exposed to the outside, and a stopper connected to seal the end of the elastic hollow fiber.

### CROSS-REFERENCE TO RELATED APPLICATION

This application claims priority from Korean Patent Application No. 10-2022-0076551, filed on Jun. 23, 2022, the disclosure of which is incorporated herein by reference in its entirety.

### TECHNICAL FIELD

The present disclosure relates to a composite fiber capable of changing colors, and more particularly, to a composite fiber capable of discoloration by various external stimuli such as heat, electrical signals, mechanical external stimuli, etc. by filling a hollow of a hollow fiber containing a thermochromic pigment and a polymer with a liquid metal, and a manufacturing method thereof.

### BACKGROUND

Conventionally, a thermochromic fiber containing a thermochromic pigment has been usefully used in the fields of wearables, electronic products, electronic fibers, and soft robots.

The thermochromic pigment may cause a color change by a redox mechanism. Specifically, the thermochromic pigment is a temperature-chromic pigment of which a color starts to disappear when a temperature rises to a predetermined temperature or higher and returns to its original color when the temperature falls again.

Meanwhile, the existing thermochromic material is manufactured as a 2D film, and thus, it is difficult to manufacture various 2D and 3D electronic products using the fiber. In addition, when the existing thermochromic material is used for a rigid conductive filler, there is a disadvantage in that mechanical deformation is not free. Also, existing conductive fibers are materials used for the development of electronic clothing and electronic materials that require flexibility. In addition, existing metal wires exhibit stable properties in terms of conductivity, shape stability, and durability, but cannot be used for materials that require flexibility, such as newly developed flexible displays.

Therefore, research on a new composite fiber material capable of discoloration by external stimuli while having various physical properties, such as electrical conductivity and super-stretchability, has been conducted.

### SUMMARY

An object of the present disclosure is to provide a composite fiber capable of discoloration by various external stimuli while having various physical properties such as electrical conductivity and super-stretchability, and a manufacturing method thereof.

The object of the present disclosure is not limited to the above-mentioned objects. The object of the present disclosure will become more apparent from the following description, and will be implemented by the means described in the claims and a combination thereof.

A composite fiber capable of discoloration according to the present disclosure includes: an elastic hollow fiber containing a thermochromic pigment and an elastic polymer, a liquid metal filled in the hollow of the elastic hollow fiber, a metal wire having one end inserted into the liquid metal and the other end exposed to the outside, and a stopper connected to seal the end of the elastic hollow fiber.

The elastic hollow fiber may contain 0.5 to 2.0% by weight of the thermochromic pigment and 98 to 99.5% by weight of the polymer.

The elastic polymer may include at least one selected from the group consisting of natural rubber, foam rubber, acrylonitrile butadiene rubber, fluorine rubber, silicone rubber, ethylene propylene rubber, urethane rubber, chloroprene rubber, styrene butadiene rubber, chlorosulfonated polyethylene rubber, polysulfide rubber, acrylate rubber, epichlorohydrin rubber, acrylonitrile ethylene rubber, urethane rubber, polystyrene-based elastomers, polyolefin-based elastomers, polyvinyl chloride-based elastomers, polyurethane-based elastomers, polyester-based elastomers and polyamide-based elastomers, and combinations thereof.

The liquid metal may have a specific resistance of 3.0×10⁻⁷ Ωm or less, and a melting point of 30° C. or less.

The liquid metal may be gallium or an alloy containing gallium.

The stopper may be a cured epoxy resin.

A plurality of liquid metals may be filled in the hollow along a longitudinal direction of the elastic hollow fiber.

The plurality of liquid metals may be different from each other in at least one of thermal conductivity, electrical conductivity, and melting point.

The elastic hollow fiber may contain two or more of the thermochromic pigments, and the thermochromic pigments may have different degrees of color expression according to temperature.

The elastic hollow fiber may include a plurality of regions partitioned at a predetermined interval along a longitudinal direction, and the plurality of regions may include different thermochromic pigments to have different degrees of color expression.

The composite fiber may have a diameter of 400 to 2,000 μm, a Young's modulus of 0.1 to 4 M Pa or less, and an elongation of 600% or more.

The composite fiber may be discolored by external stimuli, and the external stimuli may be any one or more selected from heat, electrical signals, and mechanical external stimuli.

In addition, a composite fiber capable of discoloration according to the present disclosure includes: a hollow fiber containing thermochromic pigments and shape memory polymers (SMPs), a plurality of liquid metals filled in the hollow of the hollow fiber, a metal wire having one end inserted into the liquid metal and the other end exposed to the outside; and a stopper connected to seal the end of the hollow fiber, wherein the hollow fiber includes a plurality of regions partitioned at a predetermined interval along a longitudinal direction, and the plurality of regions include the two or more liquid metals having different melting points.

Further, a manufacturing method of a composite fiber capable of discoloration according to the present disclosure includes: preparing an elastic hollow fiber containing a thermochromic pigment and an elastic polymer fiber, injecting a liquid metal into the hollow of the elastic hollow fiber, inserting a metal wire so that one end is inserted into the liquid metal and the other end is exposed to the outside, and installing a stopper connected to seal the end of the elastic hollow fiber.

The preparing of the elastic hollow fiber includes: manufacturing a sheet by mixing the thermochromic pigment and the polymer fiber; forming a coating layer by coating the sheet on the surface of a cylindrical roller; curing the coating layer by heat treatment; and manufacturing the elastic hollow fiber by removing the roller, wherein a surface of the roller may be treated with an anti-adhesive agent.

In the manufacturing of the sheet, 0.5 to 2.0% by weight of the thermochromic pigment and 98 to 99.5% by weight of the elastic polymer may be mixed, and the sheet may be defoamed for 10 to 30 minutes at a temperature of 20 to 40° C. and a vacuum of 0.01 to 0.1 MPa.

The curing may be performed for 1 to 3 hours at a temperature of 90 to 120° C.

A plurality of liquid metals may be filled in the hollow along the longitudinal direction of the elastic hollow fiber.

The plurality of liquid metals may be different from each other in at least one of thermal conductivity, electrical conductivity, and melting point, and the different liquid metals may be alternately injected.

In the forming of the coating layer by coating the sheet, each elastic hollow fiber containing a thermochromic pigment having a different color expressed according to temperature may be differently coated for each section on the surface of the roller.

The composite fiber according to the present disclosure may be discolored by various external stimuli such as heat, electrical signals, and mechanical external stimuli while having a super-stretchability of 600% or more.

In addition, the composite fiber according to the present disclosure may be discolored by external stimuli while having electrical conductivity and super-stretchability.

Further, the composite fiber according to the present disclosure may be usefully applied in the fields of wearables, electronic products, electronic fibers, and soft robots.

Also, a manufacturing method of a composite fiber according to the present disclosure, which may be stretched to 600% or more and may be discolored by various external stimuli such as heat, electrical signals, mechanical external stimuli, etc. may be provided.

The effects of the present disclosure are not limited to the above-mentioned effects. It should be understood that the effects of the present disclosure includes all effects that can be inferred from the following descriptions.

### BRIEF DESCRIPTION OF THE DRAWINGS

FIG. 1A shows an exemplary schematic cross-sectional view of a composite fiber capable of discoloration.

FIG. 1B shows an exemplary schematic cross-sectional view before a liquid metal is filled in the hollow of an elastic hollow fiber.

FIG. 2 shows an exemplary schematic cross-sectional view of a composite fiber capable of discoloration.

FIGS. 3 and 4 show exemplary schematic cross-sectional views of a composite fiber capable of discoloration.

FIG. 5 shows a flowchart illustrating an example of a manufacturing method of a composite fiber capable of discoloration.

FIGS. 6 to 10 show views illustrating examples of each step of the manufacturing method of the composite fiber.

FIGS. 11 to 28 show results of measurement and analysis of the characteristics of the elastic hollow fiber.

### DETAILED DESCRIPTION

The above objects, other objects, features, and advantages of the present disclosure will be easily understood through the following preferred implementations related to the accompanying drawings. The present disclosure, however, is not limited to exemplary implementations described herein and may also be implemented in other forms. On the contrary, exemplary implementations introduced herein are provided to make disclosed contents thorough and complete and sufficiently transfer the spirit of the present disclosure to those skilled in the art.

Similar reference numerals have been used for similar components in describing each drawing. In the accompanying drawings, the dimensions of structures may be enlarged than the actual dimensions for clarity of the present disclosure.

It should be understood that unless otherwise specified, all numbers, values, and/or expressions expressing quantities of components, reaction conditions, polymer compositions and formulations used in the present specification are approximate values obtained by reflecting various uncertainties of the measurement that arise in obtaining these values among others in which these numbers are essentially different. Therefore, they should be understood as being modified by the term “about” in all cases. In addition, when numerical ranges are disclosed in this description, such ranges are continuous and include all values from a minimum value to a maximum value inclusive of the maximum value of such ranges, unless otherwise indicated. Furthermore, when such ranges refer to an integer, all integers from the minimum value to the maximum value inclusive of the maximum value are included, unless otherwise indicated.

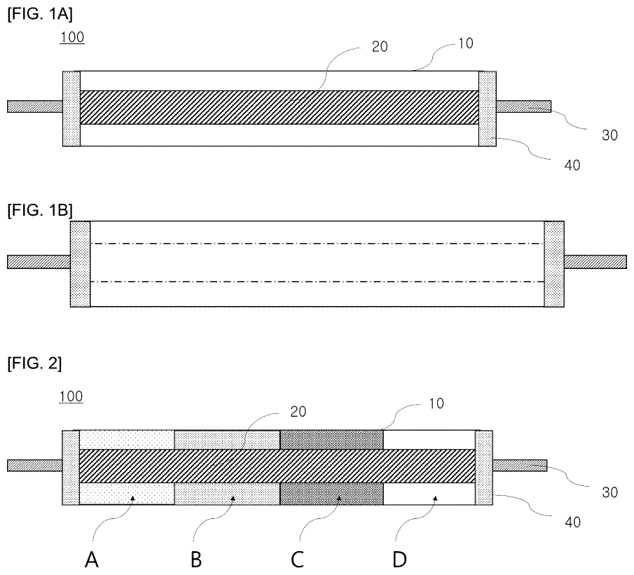

A first exemplary implementation of the present disclosure relates to a composite fiber capable of discoloration by various external stimuli. Hereinafter, the present disclosure will be described in more detail with reference to the accompanying drawings. FIG. 1A is a schematic cross-sectional view of a composite fiber capable of discoloration according to the first exemplary implementation of the present disclosure.

Referring to FIG. 1A, a configuration of the composite fiber capable of discoloration according to the first exemplary implementation of the present disclosure will be described in more detail as follows.

The composite fiber 100 capable for discoloration according to the first exemplary implementation of the present disclosure includes: an elastic hollow fiber containing a thermochromic pigment and an elastic polymer, a liquid metal 20 filled in the hollow of the elastic hollow fiber, a metal wire 30 having one end inserted into the liquid metal 20 and the other end exposed to the outside, and a stopper 40 connected to seal the end of the elastic hollow fiber.

Referring to FIG. 1B, the elastic hollow fiber 10 has a hollow inside. Here, FIG. 1B is a schematic cross-sectional view before a liquid metal is filled in the hollow of an elastic hollow fiber according to the first exemplary implementation of the present disclosure. As illustrated in FIG. 1B, it can be seen that the hollow 11 is formed inside the elastic hollow fiber 10 along the longitudinal direction of the fiber.

The elastic hollow fiber 10 may contain 0.5 to 2.0% by weight of the thermochromic pigment and 98 to 99.5% by weight of the elastic polymer.

Here, if the content of the thermochromic pigment is 0.5% by weight, a discoloration mechanism is caused by an oxidation/reduction reaction of the dye, and the degree of discoloration is degraded. If the content of the thermochromic pigment is 2.0% by weight or more, the effect on the discoloration speed and degree compared to the increased dye is insignificant.

The thermochromic pigment is a temperature-chromic pigment of which a color starts to disappear when a temperature rises to a predetermined temperature or more and returns to its original color when the temperature falls again.

The thermochromic pigments change color in response to thermal stimuli (e.g., as they change temperature, etc.). The thermochromic pigment may cause a color change by a redox mechanism. Specifically, the thermochromic pigment is a temperature-chromic pigment of which a color starts to disappear when a temperature rises to a predetermined temperature or more and returns to its original color when the temperature falls again.

For example, a THERMOCHROMIC POWDER PIGMENT product manufactured by ATLANTA CHEMICAL ENGINEERING® may be used as the thermochromic pigment.

For example, at least one selected from the group consisting of Blue-Pink 54° F. (12° C.), Red to Yellow 59° F. (15° C.), Blue-Violet 72° F. (22° C.), Green-Yellow 77° F. (25° C.), Black-Yellow 77° F. (25° C.), Red to Yellow 77° F. (25° C.), Black-Colorless 77° F. (25° C.), Black-Pink 77° F. (25° C.), Black-Blue 77° F. (25° C.), Black-Green 77° F. (25° C.), Pink-Colorless 77° F. (25° C.), Yellow-Colorless 77° F. (25° C.), Black-Purple 77° F. (25° C.), and combinations thereof may be used.

The elastic polymer may include at least one selected from the group consisting of natural rubber, foam rubber, acrylonitrile butadiene rubber, fluorine rubber, silicone rubber, ethylene propylene rubber, urethane rubber, chloroprene rubber, styrene butadiene rubber, chlorosulfonated polyethylene rubber, polysulfide rubber, acrylate rubber, epichlorohydrin rubber, acrylonitrile ethylene rubber, urethane rubber, polystyrene-based elastomers, polyolefin-based elastomers, polyvinyl chloride-based elastomers, polyurethane-based elastomers, polyester-based elastomers and polyamide-based elastomers, and combinations thereof.

In the present disclosure, a thermoplastic elastic polymer having a high elongation in response to tension and external tension may be used. Specifically, silicone rubber may be used as the elastic polymer, and more preferably, a styrene-ethylene-butylene-styrene copolymer (SEBS) may be used.

The liquid metal 20 may be filled in the hollow 11 of the elastic hollow fiber 10. The liquid metal 20 may have a specific resistance of 3.0×10⁻⁷ Ωm or less, and a melting point of 30° C. or less.

The liquid metal 20 may be gallium or a gallium-containing alloy, and more preferably eutectic gallium-indium alloy (EGaIn).

The liquid metal 20 may preferably be in a supercooling state. The liquid metal 20 is used at or below its melting point, and thus the liquid metal 20 maintains a liquid state rather than a solid state.

One end of the metal wire 30 is inserted into the liquid metal 20 and the other end of the metal wire 30 is exposed to the outside. The metal wire 30 is in contact with the liquid metal 20, and thus a current may be applied to induce heat generation through the liquid metal 20. In addition, the metal wire 30 may prevent leakage of liquid metal through insertion.

The stopper 40 is to prevent the liquid metal 20 from leaking to the outside, and is connected to seal the end of the elastic hollow fiber 10. The stopper 40 may fix the liquid metal 20 and the metal wire 30.

The stopper 40 may include an epoxy resin, specifically, a cured epoxy resin.

Next, a composite fiber capable of discoloration according to a second exemplary implementation of the present disclosure will be described with reference to FIG. 2 as follows. Here, FIG. 2 is a schematic cross-sectional view of a composite fiber capable of discoloration according to a second exemplary implementation of the present disclosure.

For reference, the second exemplary implementation is the same as the first exemplary implementation with respect to the elastic hollow fiber 10, the liquid metal 20, the metal wire 30, and the stopper 40, except that two or more types of thermochromic pigments mixed in the elastic hollow fiber 10 are used. Thus, a description thereof will be omitted.

Referring to FIG. 2A, the composite fiber 100 capable of discoloration according to the second exemplary implementation of the present disclosure may contain two or more of the thermochromic pigments in the hollow fiber. The thermochromic pigments may have different degrees of color expression according to temperature.

The hollow fiber may include a plurality of regions partitioned at a predetermined interval along the longitudinal direction, and the plurality of regions may include different thermochromic pigments to have different degrees of color expression.

Specifically, the present disclosure can implement a composite fiber 100 capable of discoloration in various degrees of color expression by using the different thermochromic pigments in each area divided by A, B, C, and D in FIG. 2A.

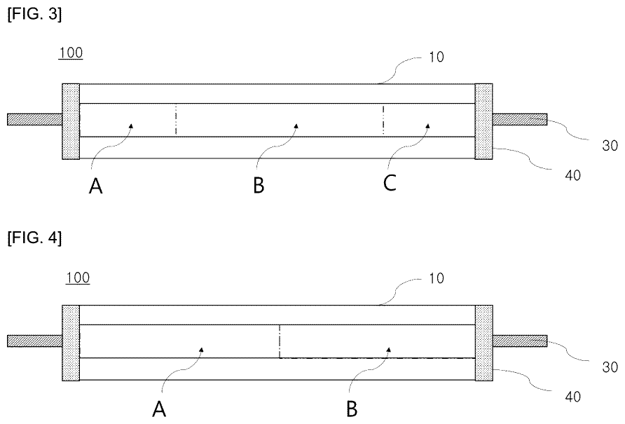

Next, a composite fiber capable of discoloration according to a third exemplary implementation of the present disclosure will be described with reference to FIGS. 3 and 4 as follows. Here, FIGS. 3 and 4 are schematic cross-sectional views of a composite fiber capable of discoloration according to the third exemplary implementation of the present disclosure.

For reference, the third exemplary implementation is the same as the first exemplary implementation with respect to the elastic hollow fiber 10, the liquid metal the metal wire 30, and the stopper 40, except that two or more types of the configuration of the liquid metal 20 filled in the hollow in the elastic hollow fiber 10 are used. Thus, a description thereof will be omitted.

Referring to FIGS. 3 and 4, a plurality of liquid metals 20 may be filled in the hollow along the longitudinal direction of the elastic hollow fiber 10.

The plurality of liquid metals 20 may be different from each other in at least one of thermal conductivity, electrical conductivity, and melting point.

Specifically, the present disclosure may implement a composite fiber 100 capable of discoloration, having different degrees of physical properties, such as strength, as the liquid metal 20 having different physical properties is used in each region partitioned by A, B or A, B, and C in FIGS. 3 and 4.

### Fourth Exemplary Implementation

Next, the composite fiber according to the fourth exemplary implementation of the present disclosure includes: a hollow fiber containing thermochromic pigments and shape memory polymers (SMPs), a plurality of liquid metals filled in the hollow of the hollow fiber, a metal wire having one end inserted into the liquid metal and the other end exposed to the outside; and a stopper connected to seal the end of the hollow fiber, wherein the hollow fiber includes a plurality of regions partitioned at a predetermined interval along the longitudinal direction, and the plurality of regions include the two or more liquid metals having different melting points.

For reference, the fourth exemplary implementation is the same as the first exemplary implementation with respect to the liquid metal, metal wire and stopper except that a shape memory polymer is used for the hollow fiber instead of the elastic polymer, and two or more kinds of the liquid metal composition filled in the hollow are used. Thus, a description thereof will be omitted.

Specifically, the present disclosure may implement a composite fiber 100 capable of sequentially changing a shape by various external stimuli due to local variable physical properties by using a shape memory polymer for the hollow fiber and using the plurality of liquid metals having different melting points.

Meanwhile, the composite fiber according to an exemplary implementation of the present disclosure may have a diameter of 400 to 2,000 μm, a Young's modulus of 0.1 to 4 MPa or less, and an elongation of 600% or more.

Thus, the composite fiber according to an exemplary implementation of the present disclosure may be discolored by external stimuli, and the external stimuli may be any one or more selected from heat, electrical signals, and mechanical external stimuli.

Specifically, the term “mechanical external stimuli” as used herein means that an external force is applied to the composite fiber, such as stretching the composite fiber.

In another aspect, the present disclosure relates to a manufacturing method of a composite fiber capable of discoloration by various external stimuli. Hereinafter, the present disclosure will be described in more detail with reference to the accompanying drawings. In the manufacturing method, for the configuration of the elastic hollow fiber, the liquid metal, the metal wire, and the stopper, a detailed description of the same configuration as described above in the above-described composite fiber will be omitted.

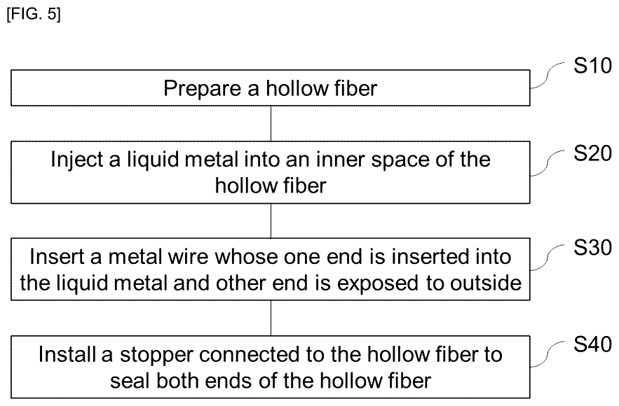

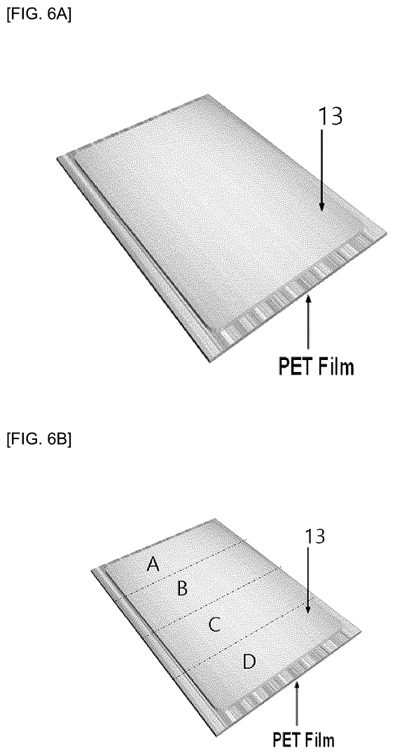

FIG. 5 is a flowchart illustrating a manufacturing method of a composite fiber capable of discoloration according to an exemplary implementation of the present disclosure. Further, referring to FIG. 5, the manufacturing method of a composite fiber capable of discoloration according to the present disclosure includes: preparing an elastic hollow fiber including a thermochromic pigment and an elastic polymer fiber (S10), injecting a liquid metal into the hollow of the elastic hollow fiber (S20), inserting a metal wire so that one end is inserted into the liquid metal and the other end is exposed to the outside (S30), and installing a stopper connected to seal the end of the elastic hollow fiber (S40).

Next, each step of the manufacturing method of a composite fiber capable of discoloration according to the present disclosure will be described in detail as follows.

First, in step S10, an elastic hollow fiber containing a thermochromic pigment and an elastic polymer fiber is manufactured.

Specifically, step S10 may include: preparing a sheet by mixing the thermochromic pigment and the polymer fiber; forming a coating layer by coating the sheet on the surface of a cylindrical roller; curing the coating layer by heat treatment; and manufacturing the elastic hollow fiber by removing the roller.

First, in step S10, a sheet may be manufactured by mixing the thermochromic pigment and the polymer fiber. In the sheet, 0.5 to 2.0% by weight of the thermochromic pigment and 98 to 99.5% by weight of the elastic polymer are mixed.

The sheet may be defoamed for 10 to 30 minutes at a temperature of 20 to 40° C. and a vacuum of 0.01 to 0.1 MPa.

Specifically, referring to FIG. 6A, the sheet 13 may be applied on a substrate such as a PET film.

Meanwhile, referring to FIG. 6B, as the sheet 13, a sheet in which mixtures of thermochromic pigments having a different compositions and the polymer fiber are separately applied to respective regions partitioned as A, B, C, and D may be manufactured. Such a sheet may implement a composite fiber capable of being variously discolored with degrees of color expression.

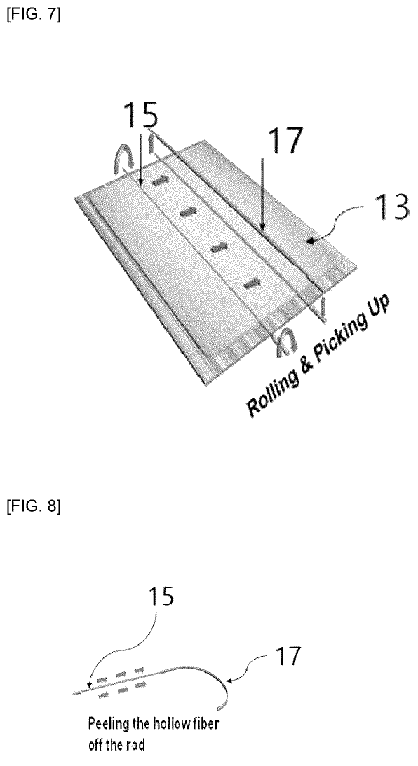

Then, referring to FIG. 7, a coating layer 17 may be formed by coating the sheet on the surface of a cylindrical roller 15. The coating layer 17 is formed by a rolling process of the roller 15, and may have a form in which the sheet 13 is wrapped on the surface of the roller 15.

The roller 15 may use a metal whose surface is treated with an anti-adhesive agent. The anti-adhesive agent may be one commonly used to facilitate releasability in the art to which the present disclosure belongs.

Meanwhile, in the forming of the coating layer, each elastic hollow fiber containing thermochromic pigments having different colors expressed according to temperature using the sheet illustrated in FIG. 6B may be differently coated for each section on the surface of the roller.

Subsequently, the coating layer 17 coated on the surface of the roller 15 is cured by heat treatment. The heat treatment may be performed for 1 to 3 hours at a temperature of 90 to 120° C.

Then, referring to FIG. 8, the elastic hollow fiber having a hollow therein may be manufactured by removing the roller 15 from the coating layer 17.

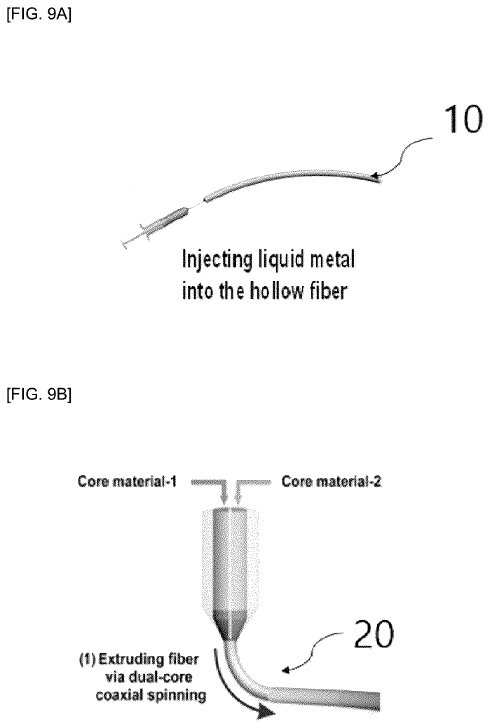

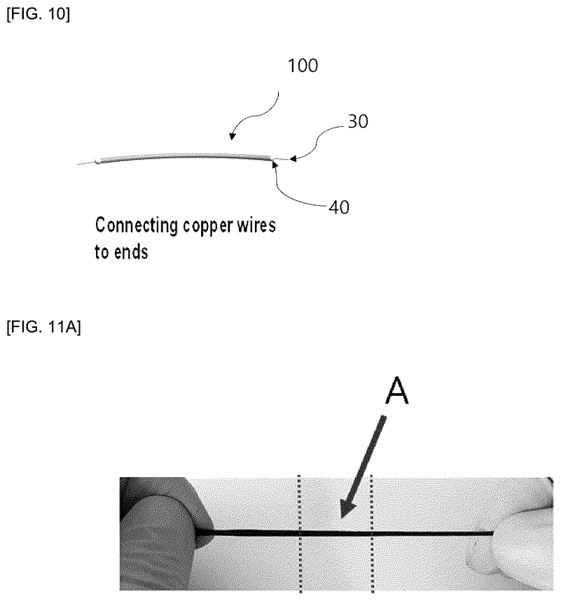

Next, in step S20, the liquid metal is injected into the hollow of the elastic hollow fiber (10). Referring to FIG. 9A, the liquid metal may be injected into the hollow of the elastic hollow fiber 10.

Meanwhile, in step S20, a plurality of liquid metals 20 may be filled in the hollow along the longitudinal direction of the elastic hollow fiber as illustrated in FIG. 9B.

The plurality of liquid metals 20 may be different from each other in at least one of thermal conductivity, electrical conductivity, and melting point, and the different liquid metals 20 may be alternately injected.

Then, in step S30, a metal wire is inserted so that one end is inserted into the liquid metal and the other end is exposed to the outside.

Finally, in step S40, a stopper connected to seal the end of the elastic hollow fiber is installed.

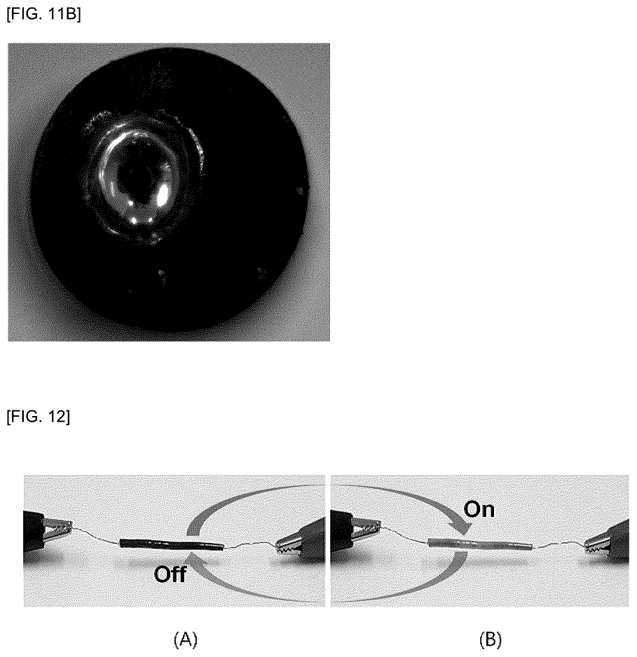

Referring to FIG. 10, finally, a composite fiber capable of discoloration configured in the form of elastic hollow fibers, liquid metal filled in the hollow of the elastic hollow fibers, metal wires 30, and stoppers 40 may be manufactured.

Hereinafter, the present disclosure will be described in more detail through specific Examples. The following Examples are only examples to assist the understanding of the present disclosure, and the scope of the present disclosure is not limited thereto.

### Preparation Example 1

A PDMS elastomer (4 g) and 0.75% by weight of a thermochromic pigment were mixed and applied to a PET film, and then bubbles were removed for 20 minutes in a vacuum of 0.06 MPa and at room temperature.

Thereafter, a steel rod subjected to fluorosilane treatment was rolled on a surface of the PDMS elastomer to perform roll coating. Then, after heat curing was performed in an oven at 100° C. for 2 hours, the fibers were peeled off from the rod. Subsequently, a liquid metal was filled in the hollow of the empty fiber, copper wires were inserted at both ends, and fixed with epoxy glue to finally manufacture a composite fiber.

Here, EGaIn was injected as the liquid metal into the hollow using a syringe. Accordingly, it could be seen that the fiber exhibited electrical conductivity, the liquid metal EGaIn had a specific resistance value of 29.4×10⁻⁶ Ω·cm, and a specific resistance value similar to that of metallic iron (9.7×10⁻⁶ Ω·cm) was ensured. Since the metal in the hollow of the fiber is in a liquid state, even if the fiber is elongated, the fiber that does not break like the solid metal such as iron and may maintain a connected state was manufactured.

The fiber may have a low Young's modulus due to its elasticity and internal hollow structure by using an elastic polymer, PDMS. In addition, there is an advantage in that it is easy to peel the PDMS fiber from the steel rod due to an extreme difference in elongation between the PDMS fiber and the steel rod.

Referring to FIGS. 11A and 11B, it could be confirmed that the composite fiber manufactured by the manufacturing method according to the present disclosure was filled with the liquid metal inside the hollow of the elastic hollow fiber.

Here, FIG. 11A illustrates a side view of the composite fiber manufactured by the manufacturing method according to the present disclosure, and FIG. 11B illustrates a cross-section in section A of FIG. 11A.

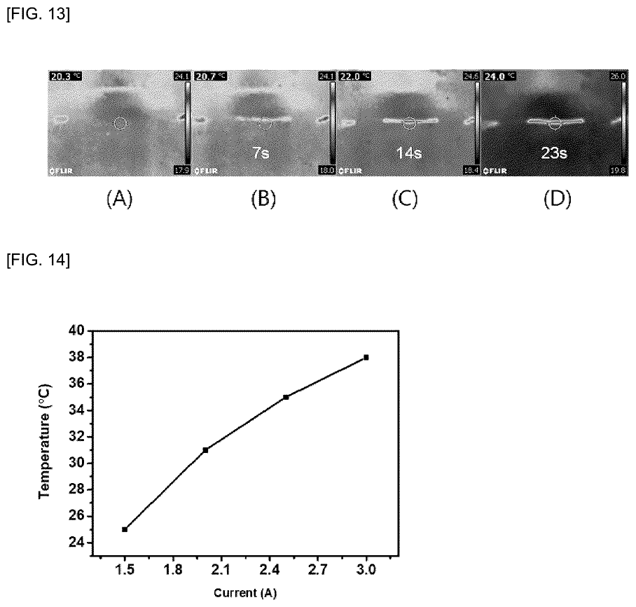

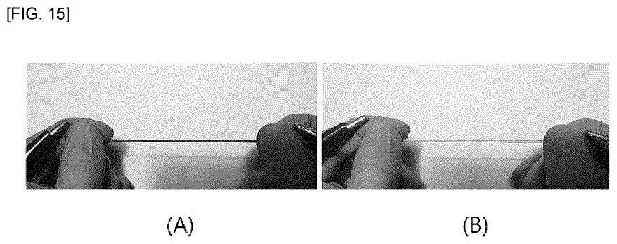

In addition, referring to FIGS. 12 and 13, it could be confirmed that the composite fiber manufactured by the manufacturing method according to the present disclosure was capable of discoloration when a current was applied. Here, FIG. 12 illustrates a state before/after the application of a current to the composite fiber according to the present disclosure. Also, FIG. 13 is obtained by photographing a temperature rise over time when a 1.5 A current was applied to the composite fiber according to the present disclosure with a thermal imaging camera.

Specifically, it could be seen that when a current was applied from the outside to the composite fiber, heat was generated in the liquid metal inside the composite fiber due to Joule heating, and a color of the composite was changed.

Continuingly, referring to FIG. 14, a temperature change according to the application of a current can be confirmed. Here, FIG. 14 is a graph illustrating the temperature change according to the application of a current.

As illustrated in the graph, it could be confirmed that when 1.5 A was applied, heat of 25° C. was generated and blue was expressed, when 2.0 A was applied, heat of 31° C. was generated and yellow was expressed, when 2.5 A was applied, heat of 35° C. was generated and pink was expressed, and when 3.0 A was applied, heat of 38° C. was generated and white was expressed.

It can be seen from the graph of FIG. 1 that the temperature increased with the change in resistance (P=I²R), and higher heat was generated due to the increase in resistance when a current is applied.

In addition, referring to FIG. 15, it could be confirmed that the composite fiber manufactured by the manufacturing method according to the present disclosure could be discolored according to stretching. Here, FIG. 15 illustrates a state before/after stretching the composite fiber according to the present disclosure. On the other hand, in FIG. 15A, A is a view illustrating a state before stretching, and B is a view illustrating a state after stretching.

As illustrated in FIG. 15, it could be confirmed that the composite fiber according to the present disclosure maintained the discoloration performance even in a deformed state if it is easily elongated by having a low Young's modulus (0.18 MPa) due to the use of an elastic polymer. It could be seen that as the fiber was stretched, the diameter of the liquid metal inside the fiber decreased, and the resistance increased due to the decrease in diameter, so that the composite fiber was discolored due to the increase in the internal temperature.

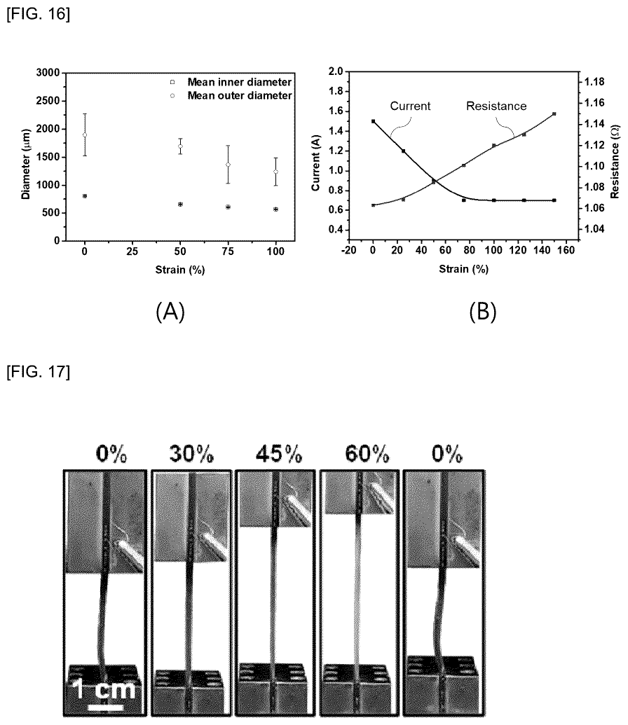

Also, referring to FIGS. 16 and 17, changes in diameter and resistance according to elongation of the composite fiber according to the present disclosure can be confirmed. Here, A in FIG. 16 illustrates the diameter according to the elongation of the composite fiber, and B in FIG. 16 illustrates the resistance according to the elongation of the composite fiber. Also, FIG. 17 is a view illustrating a discoloration time point according to the elongation.

The composite fiber according to the present disclosure may be stretched up to 600%, but, as illustrated in A in FIG. 16, when the composite fiber is stretched to 75% or more, collapse of an inner diameter occurs and the width of change of the inner diameter is smaller than that of an outer diameter. In addition, as illustrated in B in FIG. 16, the resistance increases linearly as the strain increases.

Therefore, when a lower current is applied, discoloration is expected to occur at a higher strain, because the greater the strain, the greater the change in resistance.

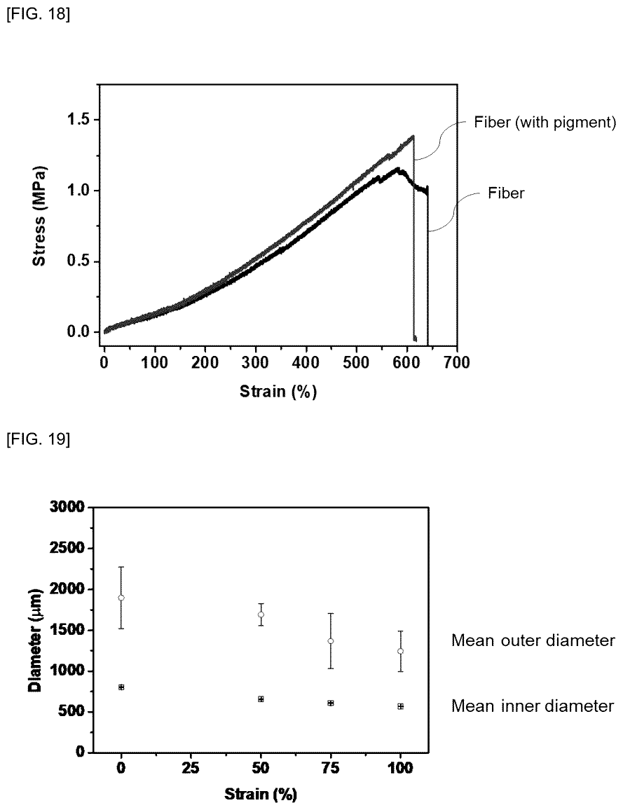

Also, referring to FIG. 18, the Young's modulus according to elongation of the composite fiber according to the present disclosure can be confirmed. The composite fiber used at this time was a silicone hollow fiber with an outer diameter of 1.6 mm and an inner diameter of 0.8 mm.

As illustrated in FIG. 18, it could be seen that a Young's modulus of the silicone fiber according to the strain is 0.18 Mpa, and the strain of the silicone fiber is 600%.

This is because as the elongation increases, such that a minute difference in breaking point occurs due to a rigid pigment.

Also, referring to FIG. 19, the diameter of the composite fiber according to the strain of the fiber can be confirmed.

As illustrated in FIG. 19, it could be seen that an inner diameter and an outer diameter of the composite fiber according to the present disclosure were reduced according to the strain, but a change range of the outer diameter was larger than that of the inner diameter of the fiber. In addition, it could be confirmed that when the composite fiber was stretched to 75% or more, the change range of the inner diameter is decreased due to a collapse of the inner diameter and was maintained at a constant level, and a fiber breakage occurred after the composite fiber was stretched to a level of 600%.

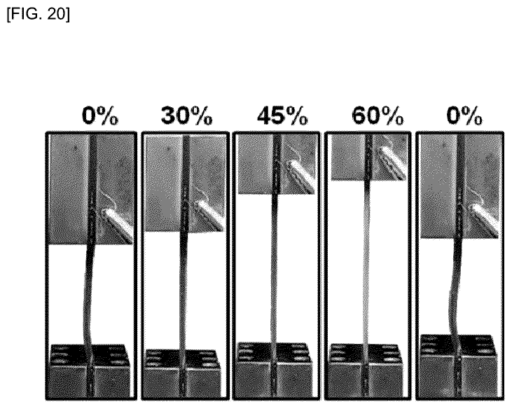

In addition, referring to FIG. 20, the time point at which the composite fiber was discolored according to the deformation and the strength of the applied current could be confirmed.

As illustrated in FIG. 20, it was confirmed that as the strain increased, the fiber was deformed and the resistance increased, resulting in discoloration of the fiber by a current (1.0 A) lower than a minimum current (1.5 A) required for color change, and after the strain was removed, the color of the fiber returned to its original state.

Therefore, the composite fiber according to the present disclosure may adjust discoloration according to the strength of the applied current and the deformation of the composite fiber.

### Preparation Example 2

Next, a composite fiber capable of discoloration according to the second exemplary implementation of the present disclosure was manufactured. For reference, in Preparation Example 2, a composite fiber in which the fibers were continuously discolored according to dispersion was manufactured by using various dyes, and the composite fiber was manufactured in the same manner as in Preparation Example 1 except that two or more types of thermochromic pigments were used.

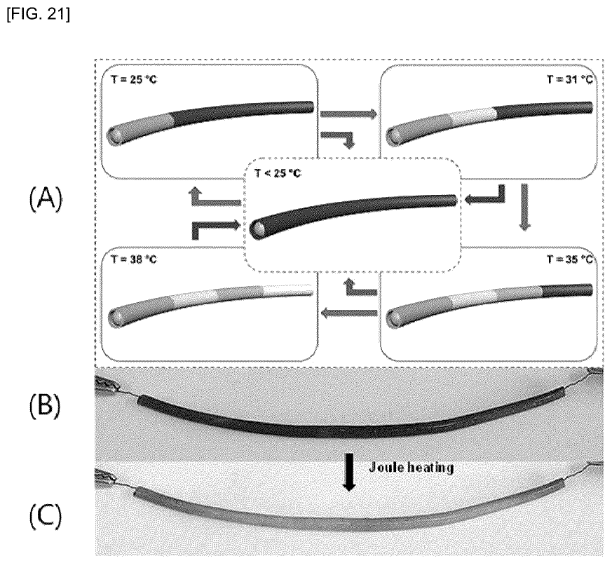

Referring to FIG. 21, it was possible to manufacture fibers that change color continuously by dispersing dyes that change color at different temperatures in the fibers.

A in FIG. 21 is a schematic view of a composite fiber manufactured according to Preparation Example 2. In addition, B in FIG. 21 is a view illustrating a form of the composite fiber manufactured according to Preparation Example 2 before a current is applied to the composite fiber, and B in FIG. 21 is a view illustrating a form of the composite fiber manufactured according to Preparation Example 2 after a current is applied to the composite fiber.

As illustrated in FIG. 21, it could be confirmed that as the applied current increased, the generated heat increased, so that the composite fiber could be continuously discolored.

### Preparation Example 3

Next, a composite fiber capable of discoloration according to the third exemplary implementation of the present disclosure was manufactured. For reference, in Preparation Example 3, a composite fiber was manufactured by additionally using a low-melting-point liquid metal, and a composite fiber was manufactured in the same manner as in Preparation Example 1 except that two or more types of liquid metal were used.

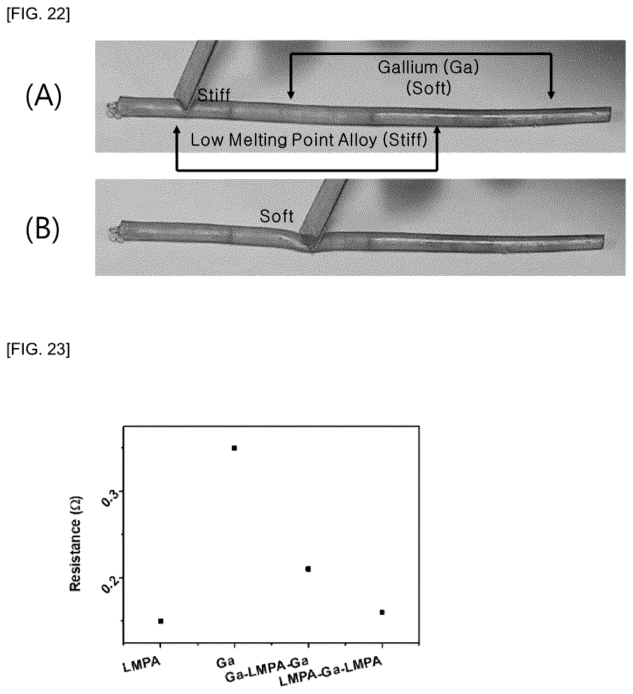

Referring to A in FIG. 22, a low melting point heterogeneous metal core composite fiber was manufactured by injecting liquid metal. Specifically, two liquid metals having different thermal conductivity, electrical conductivity, and melting point were alternately injected into the hollow fiber and manufactured. Here, as a low melting point liquid metal, a low melting point alloy (LMPA) having a melting point of 62° C. (Bi/In/Sn alloy_) was used, and as another liquid metal, gallium having a melting point of 20° C. was used.

Accordingly, as illustrated in B in FIG. 22, it could be confirmed that the composite fiber manufactured according to Preparation Example 3 had partially different strengths.

It could be seen that the composite fiber has different local heterogeneous Young's moduli at room temperature due to different melting points. Therefore, the present disclosure may manufacture a composite fiber capable of implementing a local color change of the fiber due to a difference in electrical conductivity of the heterogeneous metal core.

Subsequently, referring to FIG. 23, resistances of a conductive fiber having heterogeneous metal core can be confirmed.

Here, FIG. 23 is a graph illustrating comparison results of resistances according to the core materials in the composite fiber manufactured according to Preparation Example 3.

As illustrated in FIG. 23, it could be confirmed that the composite fiber shows different resistance values for each metal material, but entirely has metal conductivity (0.15 to 0.35Ω).

In addition, it could be seen that when the composite fiber has heterogeneous metal materials for each section, the composite fiber shows resistance between the resistance values of LMPA and Ga and still has high conductivity.

### Preparation Example 4

Subsequently, referring to FIG. 24, the Young's modulus of solid Ga and LMPA wires according to strain can be confirmed. Here, FIG. 24 is a result of evaluation and analysis of stress-strain curve properties of a solid gallium (Ga) core wire and a low melting point alloy (LMPA) core wire.

The sample used in the analysis result was manufactured by injecting a liquid metal into a polymer fiber, transforming it into a solid through a crystallization process, and then selectively removing the polymer to manufacture a free standing wire.

As illustrated in FIG. 24, it could be seen that the low melting point alloy (LMPA) exhibited a higher Young's modulus than that of gallium. Specifically, the Young's modulus of the Ga wire was measured to be 907 MPa, and the Young's modulus of the LMPA wire was measured to be 3090 MPa.

### Preparation Example 5

Subsequently, stress-Strain curve properties according to metal injection into polymer fibers were evaluated and analyzed. The sample manufactured here was manufactured by alternately injecting LMPA and Ga. Here, LMPA has a solid form and Ga has a liquid form at room temperature. For reference, LMPA has a melting point of 62° C., and Ga has a melting point of 30° C.

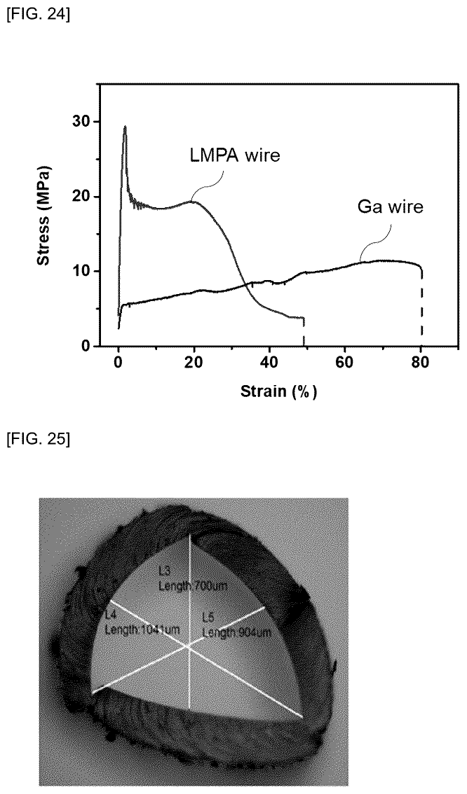

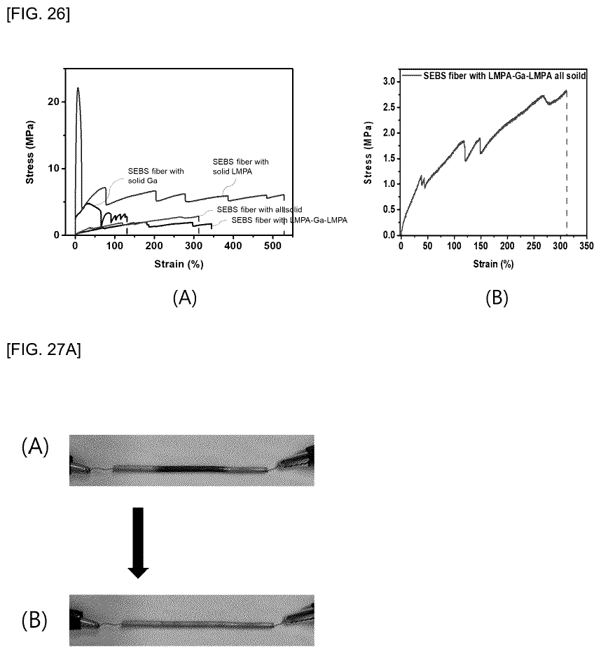

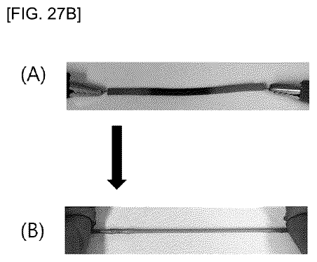

FIG. 25 is a cross-sectional image of the polymer fiber, and FIG. 26 is a stress-strain graph of the polymer fiber having a metal core.

Referring to FIGS. 25 and 26, in the case of fibers having a solid Ga core and a solid LMPA core, fracture of the metal core occurred as strain increased.

As illustrated in FIGS. 25 and 26, in the case of a LMPA (solid)-Ga (liquid)-LMPA (solid) sample, the fracture of the LMPA occurred after long strain (180%) due to the liquid gallium present in the middle.

Also, in the case of a LMPA (solid)-Ga (solid)-LMPA (solid) sample, the fracture of the solid LMPA occurred sequentially after the fracture of the solid Ga with a low modulus.

It could be confirmed that a polymer fiber having locally controlled stiffness and conductivity, and at the same time, high toughness, was fabricated.

### Preparation Example 6

Next, in Preparation Example 6, a composite fiber capable of local discoloration having a metal core was manufactured.

Here, metals having different melting points were alternately placed and local color changes were confirmed accordingly. Specifically, the composite fiber was fabricated by cross-injecting two metals with different thermal conductivities and electrical conductivities into the fiber. The liquid metals used herein were a low-melting point metal (Bi/In/Sn alloy_melting point 62° C.) and a gallium (Ga_melting point 20° C.).

First, referring to FIG. 27A, the local color change according to an increase in current can be confirmed. Here, A in FIG. 27A shows that 1.7 A is applied to the composite fiber in order to confirm the local color change according to an increase in current. And, B in FIG. 27A is a diagram of a composite fiber in which the current is increased to 2.5 A in A in FIG. 27A.

Next, referring to 27B, the local color change of the fiber due to mechanical deformation can be confirmed. Here, A in FIG. 27B illustrates that a strain of 170% was applied to the composite fiber, in order to confirm a local color change of the composite fiber due to mechanical deformation. In addition, B in FIG. 27B illustrates that a strain of 280% was applied to the composite fiber.

As illustrated in FIGS. 27A and 27B, a conductive composite fiber that changes color locally according to Joule heat after core injection may be fabricated by alternately injecting two metals with different thermal conductivity and electrical conductivity into the fiber.

In addition, it was confirmed that the composite fiber according to the present disclosure may induce additional discoloration due to the increase in resistance according to the increase in applied current and strain.

### Preparation Example 7

Next, in Preparation Example 7, a composite fiber capable of shape memory having a core of heterogeneous metal materials was manufactured. In Preparation Example 7, the composite fibers were fabricated by injecting two metals having different melting points into the fiber. The liquid metals used herein were a low-melting point metal (Bi/In/Sn alloy_melting point 62° C.) and a gallium (Ga_melting point 20° C.).

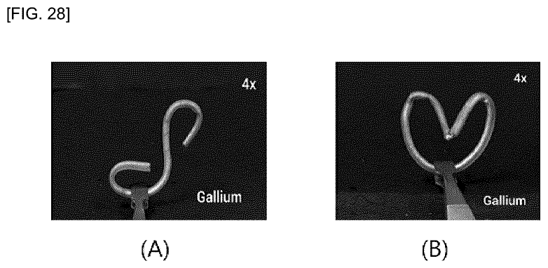

In FIG. 28, A is a view illustrating a state before applying external stimuli to the composite fiber, and B is a view illustrating a state after applying external stimuli to the composite fiber.

As shown in FIG. 28, it could be seen that the shape of the composite fiber according to the present disclosure was sequentially changed due to the locally variable physical properties implemented due to the different melting points of the core.

Thus, the composite fiber according to the present disclosure may be utilized as a shape memory polymer fiber.

Therefore, it can be confirmed that the composite fiber according to the present disclosure is a fiber capable of discoloration by various external stimuli while having conductivity through the above-described Examples and Preparation Examples.

Therefore, the composite fiber according to the present disclosure may change color by heat generated by Joule heat applied to the liquid metal core.

In addition, the composite fiber according to the present disclosure changes color even with a change in the shape of the liquid metal due to an external force and a change in resistance accordingly.

Therefore, the composite fiber according to the present disclosure may be discolored by various external stimuli such as thermal and electrical signals and mechanical deformation, is a super-stretchable material having an elongation of 600% or more, and is a fiber having excellent ductility of 4 MPa or less.

Therefore, the composite fiber according to the present disclosure will be applicable to electric parts of automobiles, artificial skin, wearable electronic devices, etc.

In addition, the manufacturing method of a composite fiber according to the present disclosure may provide a manufacturing method of an elastic polymer fiber that is locally different in Young's modulus and conductivity and may be locally discolored, through injection of metal cores having different melting points.

As described above, although exemplary implementations of the present disclosure have been described, it will be understood by a person skilled in the art to which the present disclosure belongs that the present disclosure may be implemented in other specific forms without changing the technical spirit or essential features thereof. Therefore, it is to be understood that exemplary implementations described hereinabove are illustrative rather than being restrictive in all aspects.

What is claimed is:

1. A composite fiber configured to change color, comprising:
an elastic hollow fiber comprising a thermochromic pigment and an elastic polymer;
a liquid metal provided at an inner space of the elastic hollow fiber;
a metal wire having one end inserted into the liquid metal and the other end exposed to an outside of the elastic hollow fiber; and
a stopper sealing an end of the elastic hollow fiber.

2. The composite fiber of claim 1, wherein the elastic hollow fiber comprises an amount of 0.5 to 2.0% by weight of the thermochromic pigment and an amount of 98 to 99.5% by weight of the elastic polymer.

3. The composite fiber of claim 1, wherein the elastic polymer comprises at least one selected from the group consisting of natural rubber, foam rubber, acrylonitrile butadiene rubber, fluorine rubber, silicone rubber, ethylene propylene rubber, urethane rubber, chloroprene rubber, styrene butadiene rubber, chlorosulfonated polyethylene rubber, polysulfide rubber, acrylate rubber, epichlorohydrin rubber, acrylonitrile ethylene rubber, urethane rubber, polystyrene-based elastomers, polyolefin-based elastomers, polyvinyl chloride-based elastomers, polyurethane-based elastomers, polyester-based elastomers and polyamide-based elastomers, and any combinations thereof.

4. The composite fiber of claim 1, wherein the liquid metal has a specific resistance of 3.0×10⁻⁷ Ωm or less, and a melting point of 30° C. or less.

5. The composite fiber of claim 1, wherein the liquid metal is gallium or an alloy comprising gallium.

6. The composite fiber of claim 1, wherein the stopper comprises a cured epoxy resin.

7. The composite fiber of claim 1, wherein a plurality of liquid metals is provided at the inner space of the elastic hollow fiber along a longitudinal direction of the elastic hollow fiber.

8. The composite fiber of claim 7, wherein each of the plurality of liquid metals are different from each other in at least one of thermal conductivity, electrical conductivity, and melting point.

9. The composite fiber of claim 1, wherein the elastic hollow fiber comprises two or more thermochromic pigments, and
wherein the two or more thermochromic pigments each have different degrees of color expression according to temperature.

10. The composite fiber of claim 9, wherein the elastic hollow fiber comprises a plurality of regions partitioned at a predetermined interval along a longitudinal direction, and the plurality of regions each include a different thermochromic pigment to have different degrees of color expression.

11. The composite fiber of claim 1, wherein the composite fiber has a diameter of 400 to 2,000 μm, a Young's modulus of 0.1 to 4 MPa or less, and an elongation of 600% or more.

12. The composite fiber of claim 1, wherein the composite fiber is configured to, based on external stimuli, change color, and
wherein the external stimuli comprises heat, electrical signals, mechanical external stimuli, or any combinations thereof.

13. A composite fiber configured to change color, comprising:
a hollow fiber comprising a plurality of thermochromic pigments and a plurality of shape memory polymers (SMPs);
a plurality of liquid metals provided at an inner space of the hollow fiber;
a metal wire having one end inserted into a liquid metal of the plurality of liquid metals and the other end exposed to an outside of the hollow fiber; and
a stopper sealing an end of the hollow fiber,
wherein the hollow fiber includes a plurality of regions partitioned at a predetermined interval along a longitudinal direction, and the plurality of regions include the plurality of liquid metals having different melting points.

14. A manufacturing method of a composite fiber configured to change color, the method comprising:
preparing an elastic hollow fiber comprising a thermochromic pigment and an elastic polymer fiber;
injecting a liquid metal into an inner space of the elastic hollow fiber;
inserting one end of a metal wire into the liquid metal, wherein the other end is exposed to an outside of the elastic hollow fiber; and
installing a stopper coupled to the elastic hollow fiber to seal an end of the elastic hollow fiber.

15. The manufacturing method of claim 14, wherein the preparing of the elastic hollow fiber comprises:
manufacturing a sheet by mixing the thermochromic pigment and the elastic polymer fiber;
forming a coating layer by applying the sheet on a surface of a cylindrical roller;
curing the coating layer by heat treatment; and
manufacturing the elastic hollow fiber by removing the cylindrical roller,
wherein the surface of the cylindrical roller is treated with an anti-adhesive agent.

16. The manufacturing method of claim 15, wherein in the manufacturing of the sheet comprises:
mixing an amount of 0.5 to 2.0% by weight of the thermochromic pigment and an amount of 98 to 99.5% by weight of the elastic polymer, and
defoaming the sheet for 10 to 30 minutes at a temperature of 20 to 40° C. and a vacuum of 0.01 to 0.1 MPa.

17. The manufacturing method of claim 15, wherein the curing is performed for 1 to 3 hours at a temperature of 90 to 120° C.

18. The manufacturing method of claim 14, wherein a plurality of liquid metals is provided at the inner space of the elastic hollow fiber along a longitudinal direction of the elastic hollow fiber.

19. The manufacturing method of claim 18, wherein each of the plurality of liquid metals are different from each other in at least one of thermal conductivity, electrical conductivity, and melting point, and wherein the plurality of liquid metals are alternately injected.

20. The manufacturing method of claim 15, wherein the forming of the coating layer by applying the sheet comprises:
coating the elastic hollow fiber, wherein the elastic hollow fiber comprises a plurality of regions partitioned at a predetermined interval along a longitudinal direction and the plurality of regions each include a different thermochromic pigment, and wherein the thermochromic pigment is configured to, based on a temperature, express a different color, such that each region is differently coated.
